(19) United States
(12) Patent Application Publication
(10) Pub. No.: US 2006/0076111 A1
(43) Pub. Date: Apr. 13, 2006

(54) Method and unit for applying a label to an article

(76) Inventors: Mario Spatafora, Granarolo (IT); Salvatore Carboni, Bologna (IT); Enrico Campagnoli, Sant' Agata Bolognese (IT)

Correspondence Address: OSTROLENK FABER GERB & SOFFEN, 1180 AVENUE OF THE AMERICAS, NEW YORK, NY, 100368403, US

(21) Appl. No.: 11/233,150

(22) Filed: Sep. 22, 2005

(30) Foreign Application Priority Data
Sep. 22, 2004 (IT) BO2004A000589

(51) Int. Cl. B65C 1/00; B65C 1/04; B65C 9/08

(52) U.S. Cl. 156/569; 156/570; 53/136.1

(57) ABSTRACT

A method and unit for applying a label to an article, whereby a supporting head is fed by a conveyor along a labelling path; the label is fed to a first seat of the supporting head; the article is fed to a second seat of the supporting head; and a relative movement is produced between the first seat and the second seat of the supporting head to apply the label to the article.

The present invention relates to a method and unit for applying a label to an article.

The present invention is particularly advantageous for use on a cigarette packing machine, for applying revenue labels to packets of cigarettes, to which the following description refers purely by way of example.

In many countries, a non-removable revenue label must be applied to the outer surface of a packet of cigarettes in such a position as to be torn when the packet is unsealed, and serves to demonstrate payment of tobacco retail taxes.

### BACKGROUND OF THE INVENTION

Various types of units for applying revenue labels to packets of cigarettes on a cigarette packing machine are known, some of which are described in patents U.S. Pat. No. 5,203,953 A1, EP1125843A1, DE19730307A1, U.S. Pat. No. 5,607,526 A1, U.S. Pat. No. 5,111,633 A1, and GB2103584A.

U.S. Pat. No. 4,655,871 A1 describes a unit for supplying revenue labels on a cigarette packing machine, in which each packet coming off a packing assembly is fed along an unloading path extending through a fork-type gripper; between two arms of the gripper is stretched a revenue label removed beforehand by the gripper from a respective pocket integral with the periphery of a roller tangent to a conveyor roller, which has projections for retaining and feeding a revenue label to the relative pocket along a path tangent to a gumming roller.

EP662423A1 describes a unit for applying revenue labels to packets of cigarettes bounded by two parallel faces connected by a further face; and the unit comprises a conveyor for feeding the packets to a labelling station, and a label feeder having at least one device for retaining two opposite end portions of a label. The conveyor feeds the packets successively, with the further face downstream with respect to the travelling direction of the conveyor; and an actuator is provided to move the label-retaining device between a position interfering with the path of each packet at the labelling station, and a position of non-interference with the path.

U.S. Pat. No. 6,763,870 B1 describes a unit for applying revenue labels to packets of cigarettes travelling in a feed direction along a first path; a gripping head is fed along a second path; and each label is applied to a first face of a respective packet by inserting the gripping head between a packet and the adjacent downstream packet, and rolling the gripping head to apply the label along the first face, which is perpendicular to the feed direction.

U.S. Pat. No. 5,309,695 A1 describes a unit for applying adhesive revenue labels to packets of cigarettes. The unit comprises an endless conveyor for feeding labels along a path having a first portion extending along a portion of a packet feed path, a second portion extending from the output of the first portion to a loading station for loading the labels onto the conveyor, and a third portion extending from the loading station to the input of the first portion and through a gumming device. The conveyor is a suction conveyor, and comprises a first suction chamber, in which a vacuum is maintained selectively and which extends along the first and second portion of the label path; and a second suction chamber, in which a vacuum is maintained constantly and which extends along the third portion of the path.

Patent Application ITBO200300047A describes a device for applying a revenue label to a packet of cigarettes travelling along a conveying path. To apply the label to the packet, a gripping head is fed along a feed path by rotating the gripping head about two parallel axes, and by moving the gripping head radially with respect to one of the two axes.

U.S. Pat. No. 5,111,633 A1 describes a unit for applying revenue labels to packets of cigarettes, and which comprises a device for feeding the packets to a labelling station; and a label feeder, in turn comprising a rotary conveyor substantially tangent to the labelling station and having suction retaining means for retaining individual labels on the cylindrical surface of the rotary conveyor. Each retaining means has a folding member movable substantially radially with respect to the rotary conveyor; and actuating means for activating the folding member, and which operate between a withdrawn position with respect to the rotary conveyor, and an extracted work position at the labelling station.

Known units for applying revenue labels to packets of cigarettes are relatively cheap and easy to produce, but only perform satisfactorily at low operating speeds (roughly 400-500 applications a minute), i.e. fail to provide for precise application of revenue labels to packets of cigarettes at high operating speeds. To overcome this drawback, new types of units for applying revenue labels have been proposed, but have proved complex and expensive, while still failing to ensure good performance at very high operating speeds (roughly 700-800 applications a minute).

### SUMMARY OF THE INVENTION

It is an object of the present invention to provide a method and unit for applying a label to an article, designed to eliminate the aforementioned drawbacks, and which, in particular, are cheap and easy to implement.

According to the present invention, there are provided a method and unit for applying a label to an article, as recited in the attached Claims.

### BRIEF DESCRIPTION OF THE DRAWINGS

A non-limiting embodiment of the present invention will be described by way of example with reference to the accompanying drawings, in which:

FIG. 1 shows a schematic front view, with parts removed for clarity, of a unit for applying revenue labels to soft packets of cigarettes, and in accordance with the present invention;

FIG. 2 shows a view in perspective of a packet of cigarettes featuring a revenue label;

FIGS. 3 to 5 show larger-scale views in perspective, with parts removed for clarity, of a detail of the FIG. 1 unit in different operating positions;

FIG. 6 shows a larger-scale view in perspective, with parts removed for clarity, of an actuating device of the FIG. 1 unit.

### DETAILED DESCRIPTION OF THE INVENTION

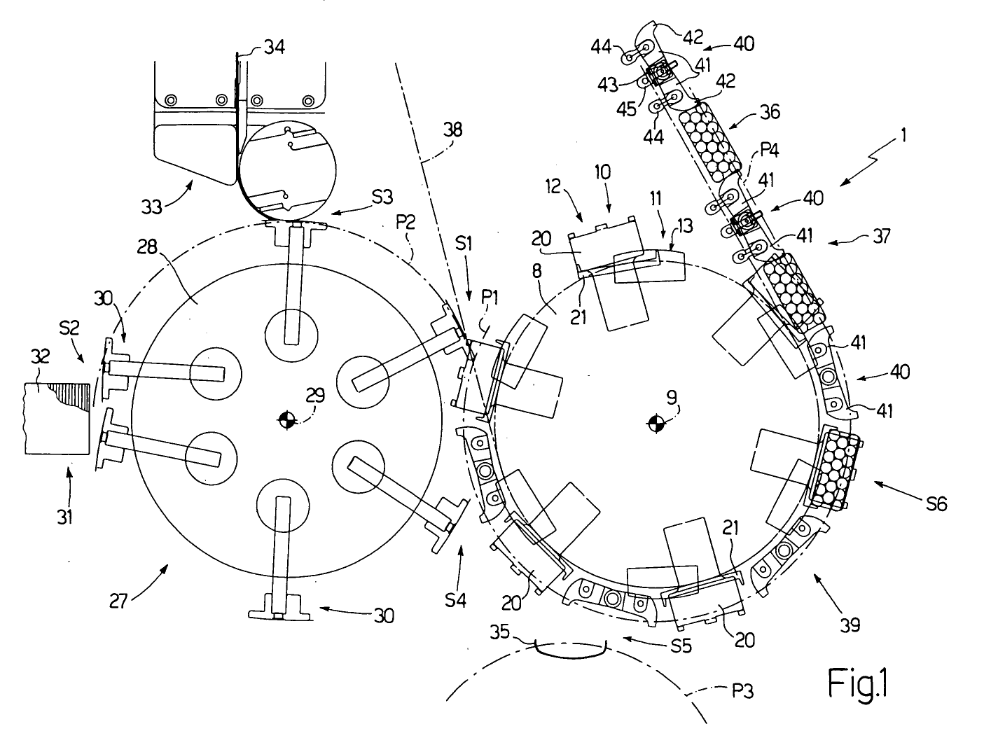

Number 1 in FIG. 1 indicates as a whole a labelling unit for applying revenue labels 2 to soft packets 3 of cigarettes on a packing machine (not shown).

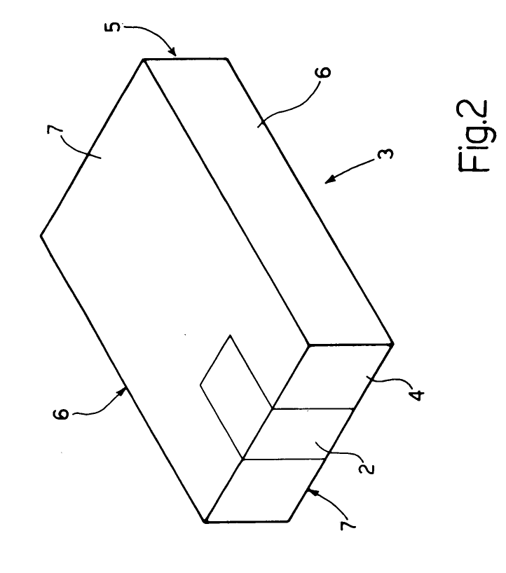

As shown in FIG. 2, each packet 3 of cigarettes contains an orderly group (not shown) of cigarettes, is parallelepiped-shaped, and is defined by a lateral surface, and by two opposite, identical, flat, respectively top and bottom end walls 4 and 5 parallel to each other and bounding the lateral surface. The lateral surface comprises two opposite, flat, parallel minor lateral walls 6, and two opposite, flat major lateral walls 7 crosswise to minor lateral walls 6. Each revenue label 2 is in the form of an elongated rectangle, and is folded into a “U” onto top end wall 4 and major lateral walls 7 of a respective packet 3 of cigarettes.

As shown in FIG. 1, labelling unit 1 comprises a wheel 8 rotating continuously about a respective central axis 9 perpendicular to the FIG. 1 plane, and supporting a number of supporting heads 10. Supporting heads 10 are equally spaced about axis 9, are fed, by rotation of wheel 8, along a circular labelling path P1, and each comprise a seat 11 for receiving a respective label 2, and a seat 12 for receiving a respective packet 3 of cigarettes.

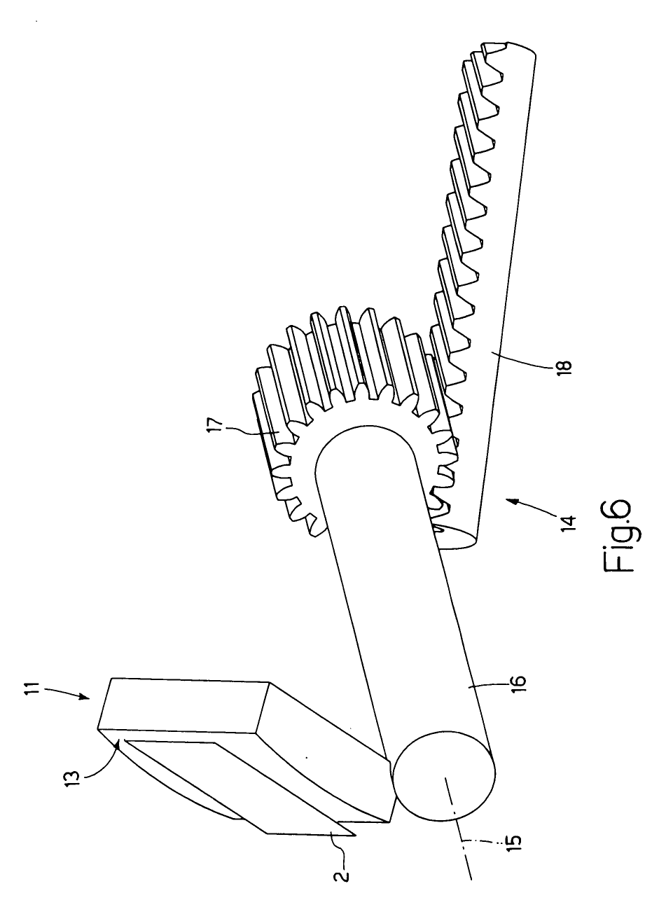

As shown in FIG. 6, each seat 11 comprises a suction surface 13 for receiving and retaining a respective label 2, and which has a slight circular curve. Each seat 11 is fitted movable to supporting head 10 to rotate, with respect to supporting head 10 and under the control of an actuating device 14, about an axis 15 slanting with respect to suction surface 13 of seat 11. More specifically, each actuating device 14 comprises a shaft 16 fitted to wheel 8 to rotate about a respective axis 15, and an outer end of which supports seat 11. An inner end of shaft 16 is integral with a gear 17 meshing with a rack 18, which slopes with respect to gear 17 and is moved by a cam system (not shown) to produce a relative movement between rack 18 and gear 17. Preferably, suction surface 13 of each seat 11 is movable with respect to shaft 16 in a direction perpendicular to suction surface 13 and in opposition to an elastic member (not shown).

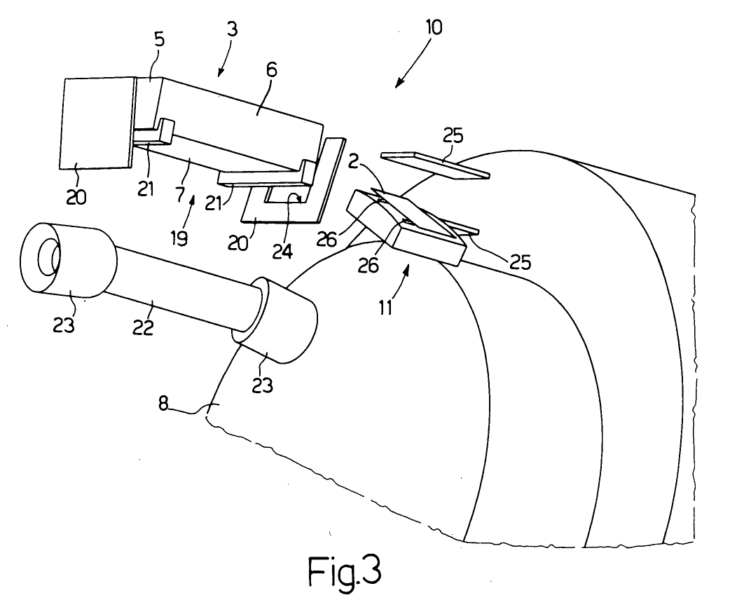

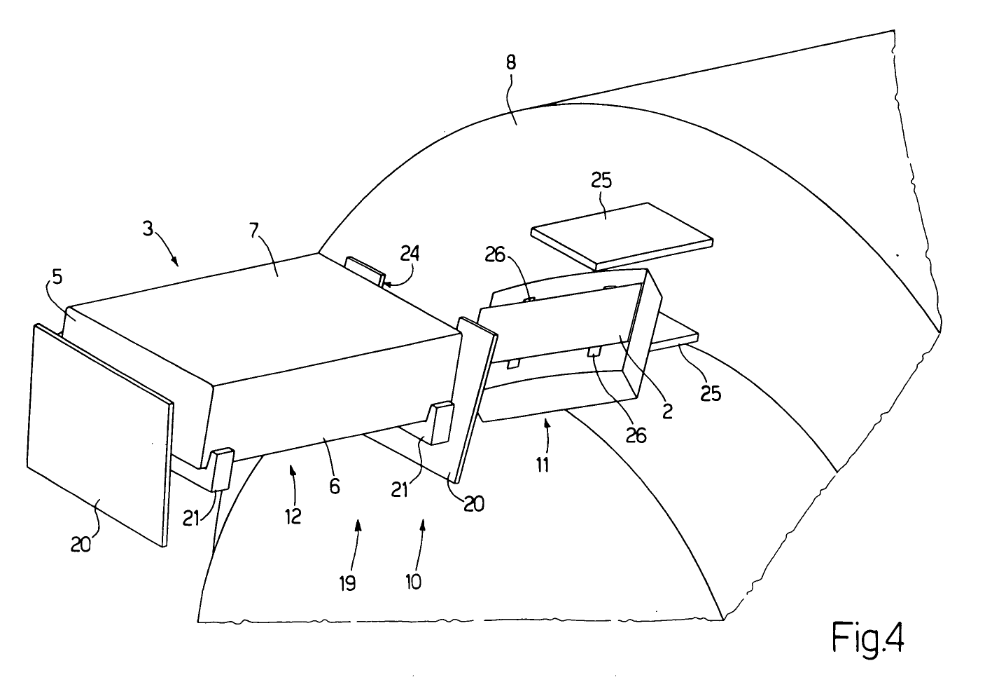

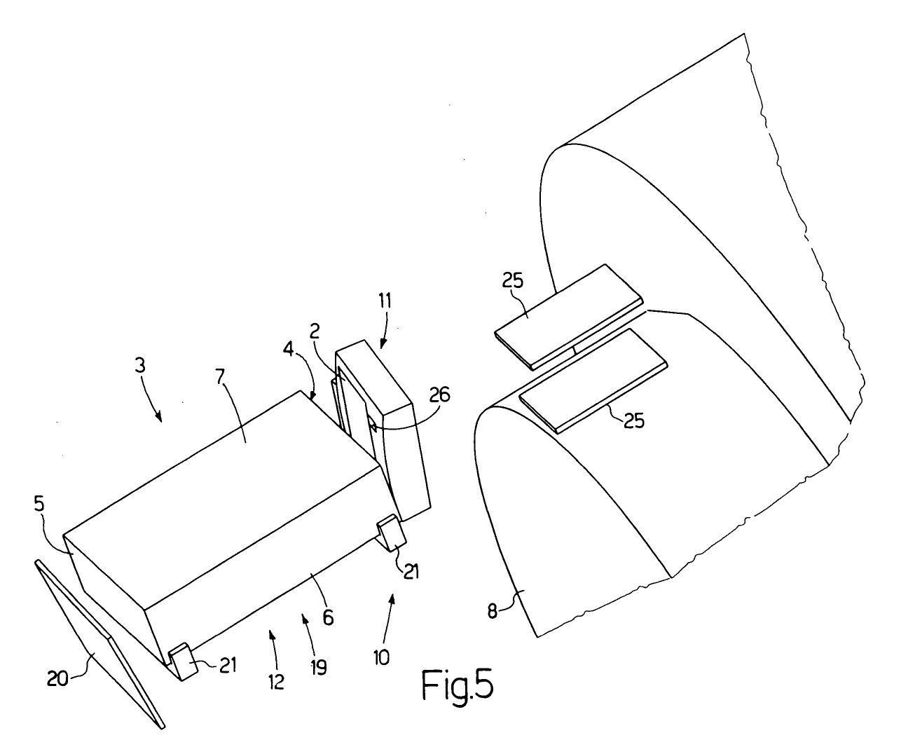

As shown in FIGS. 1 and 3, each seat 12 is fitted in a fixed position to supporting head 10, i.e. performs no movement with respect to supporting head 10 as supporting head 10 travels along labelling path P1, and comprises a fixed seating body 19 for engaging a major lateral wall 7 of packet 3, and two movable grippers 20 for engaging end walls 4 and 5 of packet 3. More specifically, each seating body 19 comprises two U-shaped supporting members 21 for engaging both a major lateral wall 7 of a packet 3, and a small portion of minor lateral walls 6 of a packet 3. In an alternative embodiment not shown, each seating body 19 may be hinged to wheel 8 to oscillate, under the control of a cam system, about an axis parallel to the rotation axis 9 of wheel 8 to assist loading and unloading of packet 3. Movable grippers 20 are fitted to supporting head 10 to rotate about respective axes sloping with respect to each other. In a preferred embodiment, movable grippers 20 are both fitted rigidly to a pin 22, rotating about an axis parallel to the rotation axis 9 of wheel 8, with the interposition of respective supporting bodies 23 sloping with respect to each other and with respect to the rotation axis of pin 22. One gripper 20 has a rectangular opening 24 to permit application of a revenue label 2 to top end wall 4 while top end wall 4 is engaged by gripper 20.

Each supporting head 10 also comprises a U-shaped folding member 25 fitted to supporting head 10 to move linearly in a direction parallel to the rotation axis 9 of wheel 8 and therefore perpendicular to labelling path P1. To allow passage of U-shaped folding member 25, each seat 11 has two through holes 26, which come out at suction surface 13. Each seat 11 preferably comprises a control member (not shown in detail) for cutting off suction through suction surface 13 of seat 11, and which is activated by passage of U-shaped folding member 25 through the through holes 26 in seat 11.

As shown in FIG. 1, labelling unit 1 comprises a feed device 27 for feeding revenue labels 2 successively to seats 11 at a feed station S1 located along labelling path P1. Feed device 27 comprises a wheel 28 rotating continuously about a respective central axis 29 parallel to rotation axis 9 of wheel 8; rotating wheel 28 supports a number of suction gripping heads 30, and feeds gripping heads 30 along a feed path P2; and each suction gripping head 30 is hinged to wheel 28 to oscillate, under the control of a cam system (not shown), about an axis parallel to the rotation axis 29 of wheel 28. Feed device 27 also comprises a pickup station S2 having a store 31 containing a stack 32 of labels; and a pickup station S3 having a cutting unit 33 (e.g. of the type described in U.S. Pat. No. 4,675,069-A1) for cutting a revenue label 2 off a continuous strip 34 of labels unwound off a reel (not shown). It should be pointed out that pickup stations S2 and S3 are used alternatively, i.e. a gripping head 30 removes a revenue label 2 from pickup station S2 or pickup station S3.

Along labelling path P1 and upstream from feed station S1, labelling unit 1 comprises a gumming station S4 for gumming an inner surface of each revenue label 2 as revenue label 2 is advanced by seat 11 of a respective supporting head 10.

Finally, labelling unit 1 comprises a feed station S5 located upstream from feed station S1 along labelling path P1; and a release station S6 located upstream from feed station S5 along labelling path P1.

At feed station S5, packets 3 of cigarettes are fed to respective seats 12 of supporting heads 10 by a number of seats 35 fed by a packing conveyor (not shown in detail) along a packing path P3 tangent to labelling path P1 at feed station S5.

At release station S6, packets 3 of cigarettes, complete with respective revenue labels 2, are released from seats 12 of supporting heads 10 to seats 36 fed by a transfer conveyor 37 along a transfer path P4 partly coincident with labelling path P1 at release station S6. Transfer conveyor 37 comprises an endless flexible support (typically a chain) looped about at least two end pulleys 39 (only one shown in FIG. 1). The end pulley 39 shown in FIG. 1 is coaxial with rotation axis 9 of wheel 8, and rotates synchronously with wheel 8. Transfer conveyor 37 also comprises a number of pairs of deformable bodies 40 connected to flexible support 38, and each pair of which are spaced apart to define a respective seat 36, and engage two opposite minor lateral walls 6 of a corresponding packet 3 of cigarettes to grip packet 3 of cigarettes between them.

Each deformable body 40 comprises a rigid jaw 41 having one end 42 for retaining packet 3 of cigarettes, and an end 43 opposite end 42. End 42 of each jaw 41 is connected to flexible support 38 by a connecting member 44 hinged to both jaw 41 and flexible support 38, while end 43 of each jaw 41 is connected to flexible support 38 by a connecting member 45 hinged to jaw 41 and fixed rigidly to flexible support 38. Jaws 41 are preferably arranged so that ends 43 of each two adjacent jaws 41 are superimposed, and the superimposed ends 43 of each two adjacent jaws 41 are both hinged to the same connecting member 45.

It is important to note that jaws 41 of transfer conveyor 37 are entirely passive, i.e. no actuating devices are provided to produce any movement between jaws 41 and flexible support 38. Given the way in which jaws 41 are connected to flexible support 38, each jaw 41 tends to oscillate with respect to end 43 when flexible support 38 assumes a curved configuration, thus opening seats 36, i.e. spreading jaws 41 defining each seat 36, when flexible support 38 assumes a curved configuration, and subsequently closing seats 36, i.e. bringing closer together jaws 41 defining each seat 36, when flexible support 38 assumes a straight configuration.

Operation of labelling unit 1 will now be described with reference to one packet 3 of cigarettes and a corresponding revenue label 2.

Label 2 is picked up by a gripping head 30 from the bottom of stack 32 in store 31 or from strip 34 at cutting unit 33, and is then transferred in known manner by gripping head 30 to seat 11 of a supporting head 10 at feed station S1. On receiving label 2, supporting head 10 continues along feed path P1 through gumming station S4, where an inner surface of label 2 is gummed in known manner.

At feed station S5, packet 3 of cigarettes is fed from a seat 35 to seat 12 of supporting head 10, by moving packet 3 with respect to both seat 35 and seat 12, and in a direction perpendicular to both packing path P3 and labelling path P1.

Up to feed station S5, seat 11 of supporting head 10 is maintained stationary with respect to supporting head 10 and seat 12. More specifically, seat 11 is maintained in such a position as to receive label 2 with suction surface 13 perpendicular to and alongside end walls 4 and 5 of packet 3. Once through feed station S5, seat 12 remains stationary with respect to supporting head 10, and seat 11 is moved with respect to seat 12 and supporting head 10 to apply label 2 to packet 3 of cigarettes under the control of actuating device 14. As stated, seat 11 is moved with respect to seat 12 and supporting head 10 by rotating about axis 15, which slants with respect to suction surface 13 of seat 11. More specifically, rotation of seat 11 about axis 15 positions suction surface 13 of seat 11 facing top end wall 4 of packet 3 of cigarettes, to apply label 2 to top end wall 4. Label 2 is then folded into a “U” onto major lateral walls 7 of packet 3 of cigarettes by U-shaped folding member 25 moving through holes 26 in seat 11. As stated, when inserted through holes 26 in seat 11, U-shaped folding member 25 activates a control member (not shown) to cut off suction through suction surface 13 of seat 11.

Finally, at release station S6, packet 3 of cigarettes, complete with label 2, is released from seat 12 of supporting head 10 to a seat 36 on transfer conveyor 37. More specifically, when fed from seat 12 to seat 36, packet 3 is maintained stationary with respect to both seat 12 and seat 36, and transfer is possible by transfer path P4 being partly coincident with labelling path P1, so that seat 36 can engage packet 3 of cigarettes while packet 3 of cigarettes is still engaged by seat 12.

Labelling unit 1 as described above has numerous advantages: it is compact, is cheap and easy to produce, and operates accurately at high operating speed. Precision labelling is particularly ensured by seat 11, for receiving a revenue label 2, and seat 12, for receiving a corresponding packet 3 of cigarettes, being conveyed together by the same supporting head 10, so that an extremely precise position of seat 11 with respect to seat 12 is guaranteed at all times, regardless of the travelling speed of supporting head 10.

In view of its numerous advantages, labelling unit 1 as described above may also be used to advantage on other automatic machines for packing products other than cigarettes, or on other than automatic packing machines, for applying a label of any type to the outer surface of an article. For example, labelling unit 1 as described above may be used to apply labels to bottles or packages of food products.

1) A method of applying a label to an article; the method comprising the steps of feeding a supporting head (10) along a labelling path (P1) by means of a conveyor (8), and feeding the label (2) to a first seat (11) of the supporting head (10); and the method being characterized by comprising the steps of feeding the article (3) to a second seat (12) of the supporting head (10); and producing a relative movement between the first seat (11) and the second seat (12) of the supporting head (10), as the supporting head (10) travels along the labelling path (P1), so as to apply the label (2) to the article (3).

2) A method as claimed in claim 1, and comprising the further step of gumming an inner surface of the label (2) as the first seat (11) of the supporting head (10) travels through a gumming station (S4).

3) A method as claimed in claim 1, wherein the second seat (12) remains stationary with respect to the supporting head (10), and the first seat (11) is moved with respect to the second seat (12) and with respect to the supporting head (10) to apply the label (2) to the article (3).

4) A method as claimed in claim 3, wherein the first seat (11) has a suction surface (13) for receiving and retaining the label (2); and the first seat (11) is moved with respect to the second seat (12) and with respect to the supporting head (10) by rotating about a first axis (15) slanting with respect to the suction surface (13) of the first seat (11).

5) A method as claimed in claim 4,. wherein the article (3) is parallelepiped-shaped, comprises two opposite parallel end walls (4, 5), and is fed by the second seat (12) along the labelling path (P1) with the two end walls (4, 5) parallel to the labelling path (P1); and the first seat (11) receives the label (2) with its suction surface (13) perpendicular to and alongside the end walls (4, 5) of the article (3), and subsequently rotates about the first axis (15) to position its suction surface (13) facing an end wall (4) of the article (3) to apply the label (2) to the end wall (4).

6) A method as claimed in claim 1, wherein the article (3) is parallelepiped-shaped, and comprises two opposite parallel end walls (4, 5), and two opposite parallel major lateral walls (7) perpendicular to the end walls (4, 5); the first seat (11) has a suction surface (13) for receiving and retaining the label (2); the relative movement between the first seat (11) and the second seat (12) positions the suction surface (13) facing an end wall (4) of the article (3) to apply the label (2) to the end wall (4); and there is provided a further step of folding the label (2) into a “U” about the article (3), so that two opposite ends of the label (2) contact the major lateral walls (7).

7) A method as claimed in claim 6, wherein the further step of folding the label (2) into a “U” about the article (3) comprises feeding a U-shaped folding member (25) through two through holes (26) in the first seat (11).

8) A method as claimed in claim 7, wherein suction through the suction surface (13) of the first seat (11) is cut off by passage of the U-shaped folding member (25) through the through holes (26) in the first seat (11).

9) A method as claimed in claim 1, wherein the article (3) is parallelepiped-shaped, and comprises two opposite parallel end walls (4, 5), and two opposite parallel major lateral walls (7) perpendicular to the end walls (4, 5) ; and the second seat (12) engages a major lateral wall (7) of the article (3) by means of a fixed seating body (19), and engages the end walls (4, 5) of the article (3) by means of two movable grippers (20).

10) A method as claimed in claim 1, wherein the step of feeding the label (2) to the first seat (11) of the supporting head (10) comprises feeding a suction gripping head (30) along a feed path; picking up the label (2) by means of the suction gripping head (30); and transferring the label (2) from the suction gripping head (30) to the first seat (11).

11) A method as claimed in claim 10, wherein the feed path extends through a first pickup station (S2) at a store (31) containing a stack (32) of labels, and through a second pickup station (S3) at a cutting unit (33) for cutting a label (2) off a continuous strip (34) of labels unwound off a reel.

12) A method as claimed in claim 1, and comprising the further steps of feeding the article (3) to the second seat (12) of the supporting head (10) from a third seat (35) fed by a packing conveyor along a packing path (P3) tangent to the labelling path (P1); and releasing the article (3) from the second seat (12) of the supporting head (10) to a fourth seat (36) fed by a transfer conveyor (37) along a transfer path (P4) partly coincident with the labelling path (P1).

13) A method as claimed in claim 12, wherein the step of feeding the article (3) from the third seat (35) to the second seat (12) comprises moving the article (3) with respect to both the third seat (35) and the second seat (12) and in a direction perpendicular to both the packing path (P3) and the labelling path (P1).

14) A method as claimed in claim 12, wherein the step of feeding the article (3) from the second seat (12) to the fourth seat (36) comprises maintaining the article (3) stationary with respect to both the second seat (12) and the fourth seat (36).

15) A unit for applying a label to an article; the unit (1) comprising a supporting head (10) having a first seat (11) for receiving the label (2), and a first conveyor (8) for feeding the supporting head (10) along a labelling path (P1); and the unit (1) being characterized in that the supporting head (10) comprises a second seat (12) for receiving the article (3), and an actuating device (14) for producing a relative movement between the first seat (11) and the second seat (12) of the supporting head (10), as the supporting head (10) travels along the labelling path (P1), so as to apply the label (2) to the article (3).

16) A unit as claimed in claim 15, and comprising a gumming station (S4) located along the labelling path (P1) and for gumming an inner surface of the label (2).

17) A unit as claimed in claim 15, wherein the second seat (12) is fixed on the supporting head (10);
and the first seat (11) is fitted movably to the supporting head (10), and is moved by the actuating device (14) with respect to the supporting head (10) and the second seat (12) to apply the label (2) to the article (3).

18) A unit as claimed in claim 17, wherein the first seat (11) has a suction surface (13) for receiving and retaining the label (2); and the first seat (11) is fitted to the supporting head (10) by a shaft (16), which is rotated, by the actuating device (14) and with respect to the second seat (12) and the supporting head (10), about a first axis (15) slanting with respect to the suction surface (13) of the first seat (11).

19) A unit as claimed in claim 18, wherein the suction surface (13) is movable with respect to the shaft (16) in a direction perpendicular to the suction surface (13).

20) A unit as claimed in claim 19, wherein the suction surface (13) is movable with respect to the shaft (16) in a direction perpendicular to the suction surface (13) and in opposition to an elastic member.

21) A unit as claimed in claim 18, wherein the actuating device (14) comprises a gear (17) integral with the shaft (16); a rack (18) meshing with the gear (17) and sloping with respect to the gear (17); and a cam system for moving the rack (18) to produce a relative movement between the rack (18) and the gear (17).

22) A unit as claimed in claim 15, wherein the article (3) is parallelepiped-shaped, and comprises two opposite parallel end walls (4, 5), and two opposite parallel major lateral walls (7) perpendicular to the end walls (4, 5); the first seat (11) has a suction surface (13) for receiving and retaining the label (2); the relative movement between the first seat (11) and the second seat (12) positions the suction surface (13) facing an end wall (4) of the article (3) to apply the label (2) to the end wall (4); and a U-shaped folding member (25) is provided to fold the label (2) into a “U” about the article (3), so that two opposite ends of the label (2) contact the major lateral walls (7) of the article (3).

23) A unit as claimed in claim 22, wherein the first seat (11) has two through holes (26) through which the U-shaped folding member (25) moves.

24) A unit as claimed in claim 23, wherein the first seat (11) has a control member for cutting off suction through the suction surface (13) of the first seat (11), and which is activated by passage of the folding member (25) through the through holes (26) in the first seat (11).

25) A unit as claimed in claim 15, wherein the article (3) is parallelepiped-shaped, and comprises two opposite parallel end walls (4, 5), and two opposite parallel major lateral walls (7) perpendicular to the end walls (4, 5); and the second seat (12) comprises a fixed seating body (19) for engaging a major lateral wall (7) of the article (3), and two movable grippers (20) for engaging the end walls (4, 5) of the article (3).

26) A unit as claimed in claim 25, wherein the movable grippers (20) are fitted to the supporting head (10) to rotate about corresponding second axes inclined with respect to each other.

27) A unit as claimed in claim 25, wherein the movable grippers (20) are mounted rigidly on one rotating pin with the interposition of respective supporting bodies inclined with respect to each other and with respect to the axis of rotation of the pin.

28) A unit as claimed in claim 15, wherein a feed device (27) feeds the label (2) to the first seat (11), and comprises a suction gripping head (30), and a second conveyor (28) for feeding the suction gripping head (30) along a feed path.

29) A unit as claimed in claim 28, wherein the feed device (27) comprises a first pickup station (S2) having a store (31) containing a stack (32) of labels; and a second pickup station (S3) having a cutting unit (33) for cutting a label (2) off a continuous strip (34) of labels unwound off a reel.

30) A unit as claimed in claim 28, wherein the suction gripping head (30) is hinged to the second conveyor (28) to oscillate under the control of a cam system.

31) A unit as claimed in claim 15, wherein the article (3) is fed to the second seat (12) of the supporting head (10) from a third seat (35) fed by a packing conveyor along a packing path (P3) tangent to the labelling path (P1); and the article (3) is released from the second seat (12) of the supporting head (10) to a fourth seat (36) fed by a transfer conveyor (37) along a transfer path (P4) partly coincident with the labelling path (P1).

32) A unit as claimed in claim 31, wherein the first conveyor (8) is a drum mounted to rotate about a second axis; and the transfer conveyor (37) comprises an endless flexible support (38), and an end pulley (39) coaxial with the second axis and about which the flexible support (38) extends.

33) A unit as claimed in claim 32, wherein the transfer conveyor (37) comprises a pair of deformable bodies (40), which are connected to the flexible support (38), are spaced apart to define the fourth seat (36) between them, and engage two opposite walls (6) of the article (3) to grip the article (3) between them; each deformable body (40) comprises a rigid jaw (41) having a first end (42) for retaining the article (3), and a second end (43) opposite the first end (42); the first end (42) is connected to the flexible support (38) by a first connecting member (44) hinged to both the jaw (41) and the flexible support (38); and the second end (43) is connected to the flexible support (38) by a second connecting member (45) hinged to the jaw (41) and fixed rigidly to the flexible support (38).

34) A conveyor for conveying articles, and comprising an endless flexible support (38) extending about at least two end pulleys (39); a number of seats (36) defined along the flexible support (38) and for receiving respective articles (3); and a corresponding number of pairs of deformable bodies (40) connected to the flexible support (38), and each pair of which are spaced apart to define a respective seat (36) between them, and engage two opposite walls (6) of a corresponding article (3) to grip the article (3) between them; each deformable body (40) comprises a rigid jaw (41) having a first end (42) for retaining the article (3), and a second end (43) opposite the first end (42); and the conveyor (37) being characterized in that the first end (42) of each jaw (41) is connected to the flexible support (38) by a first connecting member (44) hinged to both the jaw (41) and the flexible support (38); and the second end (43) of each jaw (41) is connected to the flexible support (38) by a second connecting member (45) hinged to the jaw (41) and fixed rigidly to the flexible support (38).

35) A conveyor as claimed in claim 34, wherein the jaws (41) are so arranged that the second ends (43) of each two adjacent jaws (41) are superimposed.

36) A conveyor as claimed in claim 35, wherein the superimposed second ends (43) of each two adjacent jaws (41) are both hinged to the same second connecting member (45).
